(19) United States
(12) Patent Application Publication
(10) Pub. No.: US 2011/0180237 A1
(43) Pub. Date: Jul. 28, 2011

(54) WELDING A METAL PRODUCT

(76) Inventor: John Clifford Hobbins, Hampshire (GB)

(21) Appl. No.: 12/675,779

(22) PCT Filed: Aug. 28, 2008
(86) PCT No.: PCT/GB08/02902

§ 371 Date: Feb. 27, 2010

(30) Foreign Application Priority Data
Aug. 29, 2007 (GB) 0716808.1
Aug. 29, 2007 (GB) 0716809.9

(51) Int. Cl. F28D 15/04; B23K 26/00

(52) U.S. Cl. 165/104.26; 219/121.64; 219/121.63

(57) ABSTRACT

A method of forming a welded metal product from a workpiece, comprising a sheet and a counterpart to which the sheet is to be welded, consisting in the steps of:
providing:
   a workpiece support having a support surface for a workpiece counterpart,
   means for:
      gripping opposite edges of a workpiece sheet at respective opposite edges of the workpiece support,
      drawing the opposite sheet edges in a direction having a component from a counterpart on the support surface towards the support surface and
      holding the opposite sheet edges in their drawn position,
   a robotic device associated with the workpiece support and
   a laser welding head arranged to be moved by the robotic device in at least two dimensions with respect to the workpiece support, and to maintain a welding gap from a free face of the workpiece sheet on the supported counterpart in accordance with an array welds to be formed in welding together the sheet and the counterpart;
placing a workpiece counterpart on the workpiece support;
placing a workpiece sheet on the counterpart;
gripping, drawing and holding taught the workpiece sheet by opposite edges thereof to lie against the counterpart, captivating the latter, with the free face of the workpiece sheet defining a regular surface;
setting up the combination of the workpiece support, the robotic device and the laser welding head such that the welding gap is maintained between the laser welding head and the regular surface throughout traversing of the laser welding head for forming the array of welds;
traversing the laser welding head across the workpiece sheet and making the array of laser welds, thereby welding together the sheet and the counterpart, the array being two dimensional with respect to the sheet.

The present invention relates to a method of forming a welded metal product, particularly though not exclusively a product comprised of two metal sheets.

Welding metal sheets can be awkward. Too much heat can blow holes and too little heat can cause inadequate penetration. Spot welds are widely used to overcome these awkwardnesses, but they are not precise and by their nature are ill adapted to linear welds. Increasingly adhesive is used to bond metal. However, in some instances welding is required for weld strength.

We have sought to improve our welding techniques, primarily for the manufacture of heat pipes as used in solar collectors.

Conventional solar collectors are of two types:
Sheet metal panels in the nature of domestic radiators (with the obvious difference that water is pumped through for heat collection as opposed to heat release), in particular the circulated water is passed through the entirety of the panel;
Glass heat pipes, which collect heat along their length and release it to a heat exchanger at their upper end. The heat exchanger also called the condenser in the art, because it condenses liquid to pass back down the pipes for recirculation. “Heat exchanger” is used in this specification.

There have been proposals for metallic heat pipes, which are at once cheaper and more robust. ASME publication No 76-WA/Sol-12, entitled “Heat Pipes in Flat Plate Solar Collectors” by W B Biernet and D A Wolf was read at the Winter Annual Meeting of the Solar Energy Division on 5 Dec. 1976. It describes the use of modified Roll Bond Panels for heat pipes. Roll bonding is used for interconnecting aluminium sheets in selected areas by rolling them together at elevated pressure. It is widely used for refrigerator evaporators, but we do not believe that it is suitable for high pressure applications as in solar collectors where the pressure can reach hundreds of bar.

A paper entitled “A novel hybrid heat pipe solar collector/CHP system” by SB Riffat and X Zhao of the School of Built Environment, Institute of Building Technology, Nottingham University was published in 2004. It proposed “spot-welding” of the two plates of a thin membrane heat-pipe solar collector.

The object of the present invention is to provide an improved welded metal product.

According to a first aspect of the invention there is provided a method of forming a welded metal product from a workpiece comprising a sheet and a counterpart to which the sheet is to be welded, the method consisting in the steps of:
providing:
   a workpiece support having a support surface for a workpiece counterpart,
   means for:
      gripping opposite edges of a workpiece sheet at respective opposite edges of the workpiece support,
      drawing the opposite sheet edges in a direction having a component from a counterpart on the support surface towards the support surface and
      holding the opposite sheet edges in their drawn position,
   a robotic device associated with the workpiece support and
   a laser welding head arranged to be moved by the robotic device in at least two dimensions with respect to the workpiece support, and to maintain a welding gap from a free face of the workpiece sheet on the supported counterpart in accordance with an array welds to be formed in welding together the sheet and the counterpart;
placing a workpiece counterpart on the workpiece support;
placing a workpiece sheet on the counterpart;
gripping, drawing and holding taught the workpiece sheet by opposite edges thereof to lie against the counterpart, captivating the latter, with the free face of the workpiece sheet defining a regular surface;
setting up the combination of the workpiece support, the robotic device and the laser welding head such that the welding gap is maintained between the laser welding head and the regular surface throughout traversing of the laser welding head for forming the array of welds;
traversing the laser welding head across the workpiece sheet and making the array of laser welds, thereby welding together the sheet and the counterpart, the array being two dimensional with respect to the sheet.

In one alternative, the workpiece support and the gripping, drawing and holding means are fixed with respect to a chassis of the robotic device, the robotic device being adapted to move the welding head in at least two dimensions with respect to the chassis to execute the two dimensional array of welds between the workpiece sheet and counterpart.

In another alternative, the workpiece support and the gripping, drawing and holding means are mounted for movement in one dimension with respect to a chassis of the robotic device, the robotic device is adapted to move the workpiece support and the gripping, drawing and holding means in the one dimension and to move the welding head in another dimension with respect to the chassis, whereby the welding head and the workpiece sheet can execute the two dimensional array of welds between the workpiece sheet and counterpart.

In a third alternative, the workpiece support and the gripping, drawing and holding means are mounted for movement in two dimensions with respect to a chassis of the robotic device, the robotic device is adapted to move the workpiece support and the gripping, drawing and holding means in the two dimensions and to hold the welding head in still in these dimensions with respect to the chassis, whereby the welding head and the workpiece sheet can execute the two dimensional array of welds between the workpiece sheet and counterpart.

Preferably, the workpiece support is adapted to the hold the workpiece counterpart against it by drawing a vacuum between them and a vacuum is maintained between the support and the counterpart during the welding step.

Further, the workpiece support is preferably adapted to the hold the workpiece sheet against the workpiece counterpart by drawing a vacuum between them and a vacuum is maintained between the sheet and the counterpart during the welding step.

Normally, the workpiece sheet and the counterpart will be of the same order of magnitude in thickness, and their shape in a third dimension orthogonal to the two dimensions is that of the workpiece support, whereby the counterpart is a thick part, in contrast to the thinness of the sheet and rigid in contrast to the sheet's flexibility.

However, it is envisaged that the workpiece counterpart may be thicker than the workpiece sheet by an order of magnitude in thickness, with their shape in a third dimension orthogonal to the two dimensions being that of the workpiece counterpart.

Particularly where the workpiece counterpart is of sheet, it can be held on the workpiece support by action of the gripping, drawing and holding means on the workpiece.

Alternatively, where the workpiece counterpart is a rigid member, it can be held on the workpiece support by conventional clamping means.

Normally, the workpiece support, the counterpart and the two dimensional array will all be flat, with the robotic device being an X/Y or Cartesian robot or a four or six axis robot.

However, where the workpiece counterpart is curved, the robotic device will be a six axis robot. It is particularly envisaged that the workpiece support, the counterpart and the two dimensional array may all be part circularly cylindrical, the greater part of the weld length being parallel to a central longitudinal axis or being circumferential.

In the preferred embodiments, the array of welds define a plurality of heat pipes strips extending in one direction in the welded product, an interconnection strip extending in an orthogonal direction and a first inflation point, with one of the workpiece sheet and the counterpart being perforate at the first inflation point. In the interests of welding speed, the welds can be formed as dashed lines, i.e. with short lengths of weld having intermediate, but in the interest of strength they are preferably continuous. Further in the interest of strength, the welds can be double, i.e. formed as too closely spaced lines, however in the interests of allowing the sheets to splay and form a wicking groove in the lands between the heat pipes, the welds in the array are preferably single line welds.

Preferably, the array of welds includes an additional weld, peripheral to the heat pipe and interconnecting strip welds.

In one embodiment, the method includes the additional steps of:
placing the welded metal product in a hydroforming tool and
applying pressurised liquid to the first inflation point to inflate/hydroform the heat tube strips and the interconnection strip.

In another embodiment, the method includes the additional steps of:
gripping, drawing taught and holding an additional band of sheet metal for a heat exchanger across hot (in use) ends of the heat pipe strips and
forming a second array of welds between the workpiece sheet and the heat exchanger band in like manner to the first array of welds between the workpiece and the workpiece counterpart, the second array of welds defining a heat exchanger area, connections thereto and a second inflation point.

This embodiment includes the further additional steps of:
placing the welded metal product in a hydroforming tool,
applying pressurised liquid to the first inflation point to inflate/hydroform the heat tube strips and the interconnection strip,
holding the pressure of the liquid in the inflated heat pipe tube strips,
applying pressurised liquid to the second inflation point to inflate/hydroform the heat exchanger area and the connections thereto.

Then the method includes the next additional steps of:
forming welds, between the workpiece sheet and the counterpart and outside the peripheral weld, around the position of complementary connection formations to the heat exchanger,
on inflation of the heat exchanger area, including the connections thereto, inflating the workpiece sheet and the counterpart to form the complementary connection formations, whereby the connection and complementary inflations/formations in all three parts define a round orifice and
welding or soldering connection tubes into the connection formations.

Further preferred additional steps include:
forming a loop of weld between the workpiece sheet and the counterpart and/or between the workpiece sheet and the heat exchanger band (where provided) for a stiffening rib at a heat exchanger end of the heat pipe strips and a single connection to the heat exchange area,
inflating/hydroforming the stiffening rib with the heat exchange areas and the connections thereto and
withdrawing the hydroforming liquid.

Alternatively, these additional steps are replaced by:
forming a loop of weld between the workpiece sheet and the counterpart and/or between the workpiece sheet and the heat exchanger band (where provided) for a stiffening rib at a heat exchanger end of the heat pipe strips and around a third inflation point for the stiffening rib without connection to the heat exchange area and
inflating/hydroforming the stiffening rib from the third inflation point as a separation operation to inflating/hydroforming the heat exchanger area and
withdrawing the hydroforming liquid.

Whilst the hydroformed heat pipes can have a round cross-section, preferably they have diamond or hexagonal cross-sections, with the included angles at either side being equal to or less than 90°. Further they are preferably interconnected by a single transverse tube at the bottom (in use) of the device

Apparatus for forming a welded metal product from a workpiece comprising a sheet and a counterpart to which the sheet is to be welded, the apparatus comprising:
a workpiece support having a support surface for a workpiece counterpart placed thereon,
means for:
   gripping, at respective opposite edges of the workpiece support, opposite edges of a workpiece sheet placed on the workpiece counterpart,
   drawing the opposite sheet edges in a direction having a component from a counterpart on the support surface towards the support surface and
   holding the opposite sheet edges in their drawn position,
a robotic device associated with the workpiece support and
a laser welding head arranged to be moved by the robotic device in at least two dimensions with respect to the workpiece support, and to maintain a welding gap from a free face of the workpiece sheet on the supported counterpart in accordance with an array welds to be formed in welding together the sheet and the counterpart.

Preferably, the workpiece support has:
an interconnected array of grooves complementary to the array of welds to be formed and
a vacuum connection to the array,
the arrangement enabling vacuum to draw the counterpart against the support surface for welding.

Additionally, the workpiece support preferably has a peripheral counterpart seal around the vacuum grooves for sealing the workpiece to the workpiece support.

Again, it preferably has:
a further vacuum groove and connection thereto outside the counterpart seal and a vacuum connection thereto and
a further vacuum seal around the further groove,
   the arrangement enabling vacuum to draw the workpiece sheet down onto the counterpart for welding.

Where the workpiece support is rectangular or at least four sided for four sided counterpart and workpiece sheets and the gripping, drawing and holding means are arranged at two opposite side, with clamping means being provided at the other two opposite sides.

Preferably, the workpiece support is angled away from the support surface to enable the gripping, drawing and holding means to draw the workpiece sheet in the direction of the support surface.

Again, preferably:
the gripping, drawing and holding means includes clamps set back from the support surface for drawing the workpiece sheet in the direction of the support surface;
the clamps are V jaw clamps adapted to draw tight the workpiece sheet as they are tightened closed; and
the clamps are adapted to be moved away from the workpiece support for tightening the workpiece sheet.

In accordance with a preferred feature, the apparatus includes:
a second gripping, drawing and holding means for a heat exchange band arranged above and outwards of the first gripping, drawing and holding means;
rolls and actuators therefor for forcing the band downwards onto the workpiece sheet for welding thereto.

The apparatus will normally be provided in combination with a hydroforming apparatus including:
a first hydroforming tool having an array of first heat pipe concavities and
a second hydroforming tool having:
a complementary array of second heat pipe concavities and
a movable insert having:
continuations of the second heat pipe concavities and
means for its withdrawal from an advanced position in which the second heat pipe concavities and the continuations are substantially aligned to a withdrawn position hydroforming of the heat exchange band.

Normally, the first hydroforming tool and/or the second hydroforming tool and/or the movable insert has further connection and/or stiffening concavities discrete from the heat pipe concavities.

According to a third aspect of the invention, there is provided a heat collection device comprising:
a laser welded and hydroformed heat pipe panel, comprised of a metal sheet and a metal counterpart, the sheet being welded to the counterpart with an array of welds and inflated away from the counter part to form a series of heat pipes filled with heat pipe liquid, and
a laser welded and complementarily hydroformed heat exchanger, comprised of a metal sheet and a metal counterpart, the sheet being welded to the counterpart with another array of welds and inflated away from the counterpart to form inflations complementary to end portions of the series of heat pipes,
   the panel and the heat exchanger being in intimate thermal contact for condensing liquid in the heat pipe panel at one end of the series of heat pipes and transferring heat therefrom.

Normally, the heat exchanger will have:
connections at opposite ends thereof corresponding to opposite edges of the heat pipe panel and
flow deflectors in the form of respective ones of the array of welds set transverse to in/out flow direction of the connections to spread the flow in the heat exchanger.

Preferably:
the connections and the flow deflectors are set nearer the top of the heat exchanger than its bottom in its use orientation;
the heat exchanger further includes flow distributors in the form of respective ones of the array of welds, the flow distributors being aligned in lines with selected ones of the complementary inflations, the flow distributors in one line being offset in the direction of the lines from those in the next line; and
the flow distributors have length in the direction of their lines.

In one embodiment:
the heat-pipe, metal sheet and the metal counterpart are both sheets of the same thickness order of magnitude and
the heat collection device is generally flat.

In another embodiment:
the metal counterpart is thicker than the heat-pipe, metal sheet by a thickness order of magnitude.

In a third embodiment:
the metal counterpart is a casing with the heat-pipe, metal sheet extending on an external surface thereof.

Again, in one alternative the heat exchanger is:
a separately welded product, clipped and/or clinched to the heat pipe panel; includes
a top edge, in use, abutting a margin of the heat pipe panel and a bottom edge spaced transversely of the panel from the margin to cross the heat pipes;
the face of the heat exchanger directed away from the heat pipe panel is generally smooth, excluding indentations at the flow deflectors and distributors where provided.

In another alternative:
the heat exchanger is integrally welded to the heat pipe panel, the said metal counterpart of the heat exchanger being the said metal sheet of the heat pipe panel;
the face of the heat exchanger directed away from the heat pipe panel is formed complementarily to the heat pipe panel form; and
the connection points in the form have orifices opening into the inflations of the heat exchanger, the orifices being formed on one side by the sheet and counterpart of the heat pipe panel and on the other side by sheet of the heat exchanger.

Preferably the heat collection includes an inflated stiffening rib formed in the device at the heat exchanger end of the heat pipes.

Either the inflated stiffening rib is not connected to the inflated heat exchanger or the inflated stiffening rib has a single only connection to the inflated heat exchanger.

To help understanding of the invention, a specific embodiment thereof will now be described by way of example and with reference to the accompanying drawings, in which:

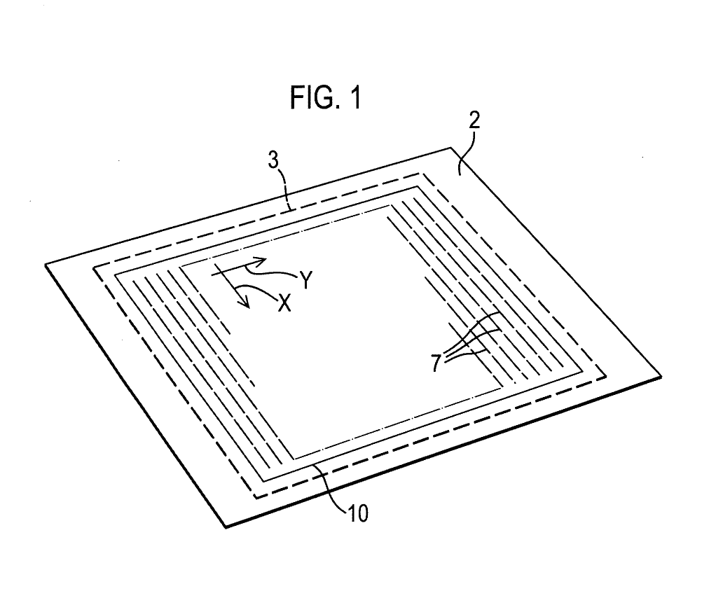

FIG. 1 is a perspective view of a product welded in accordance with the invention;

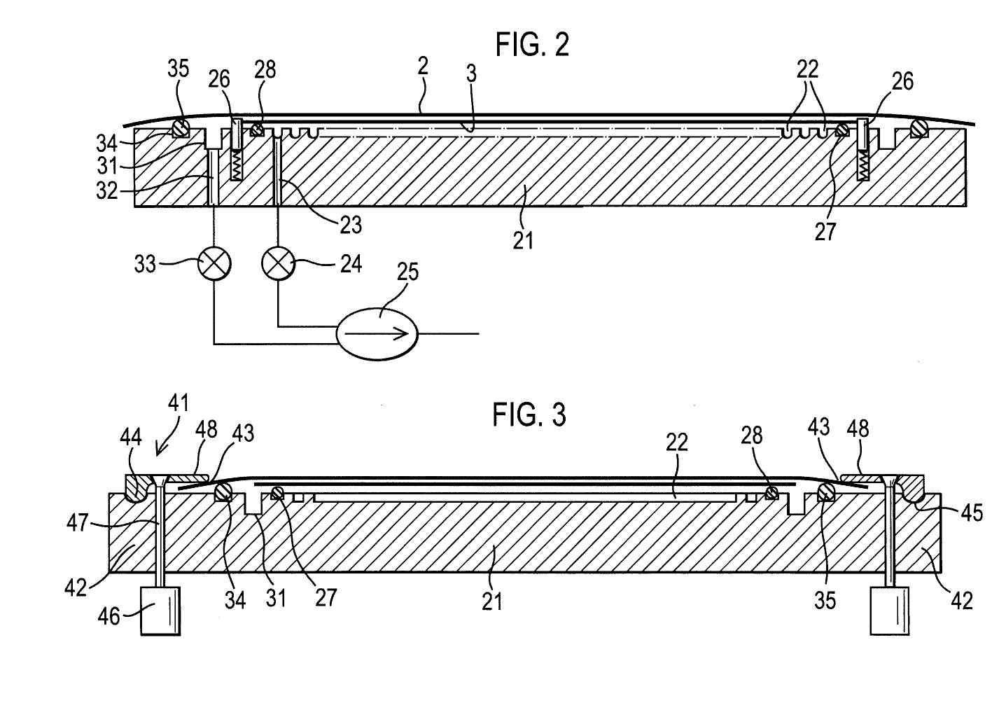

FIG. 2 is a cross-sectional view in the X direction through a welding bed set up for performing the method of the invention;

FIG. 3 is a similar cross-sectional view in the Y direction through the welding bed, showing edge clamps;

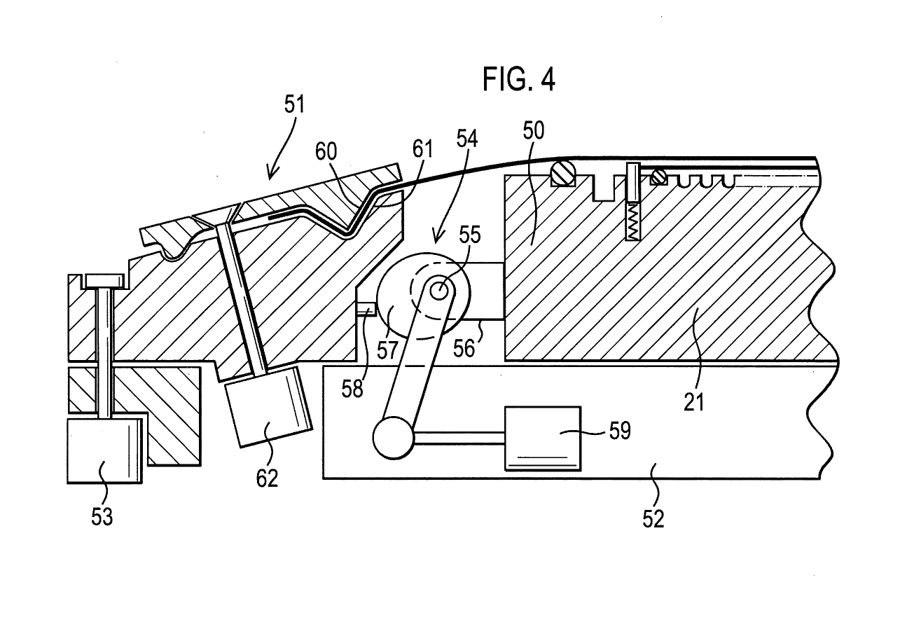

FIG. 4 is a scrap view in the X direction of the end of the welding bed showing another end clamp;

FIG. 5 is a perspective view of an X/Y robotic device supporting a welding laser above the welding bed;

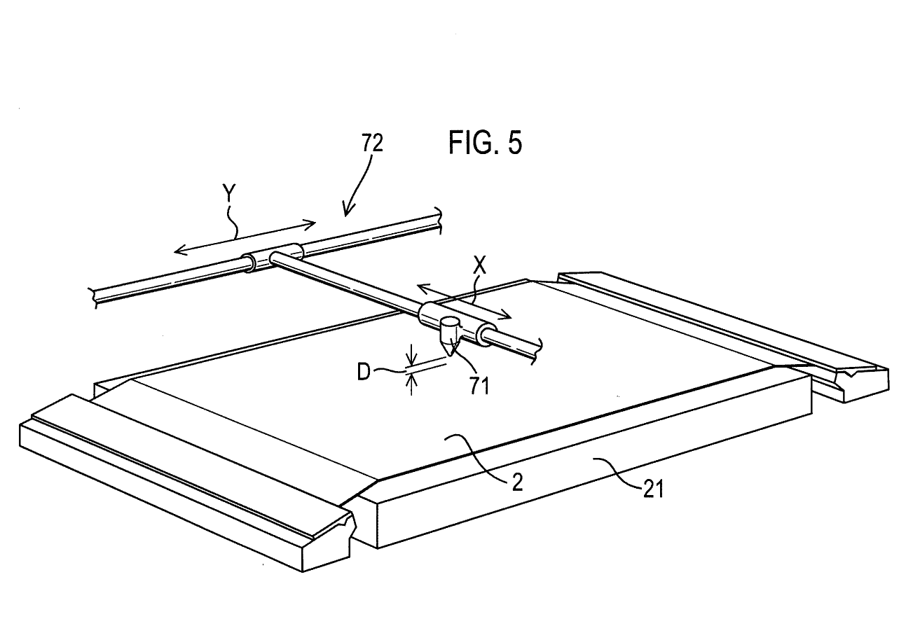

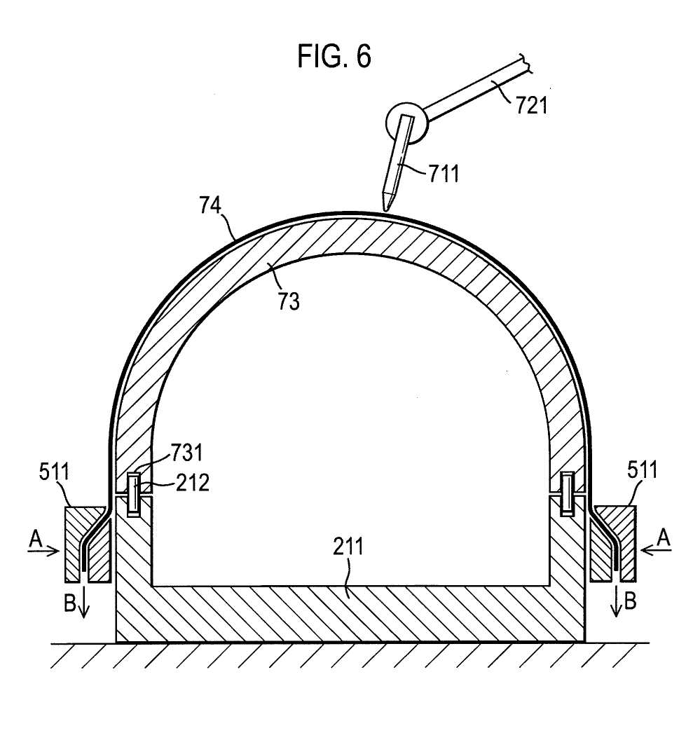

FIG. 6 is a cross-sectional view similar to FIG. 2 of a single sheet being held against a curved half casing for welding of the sheet to the casing in accordance with the invention;

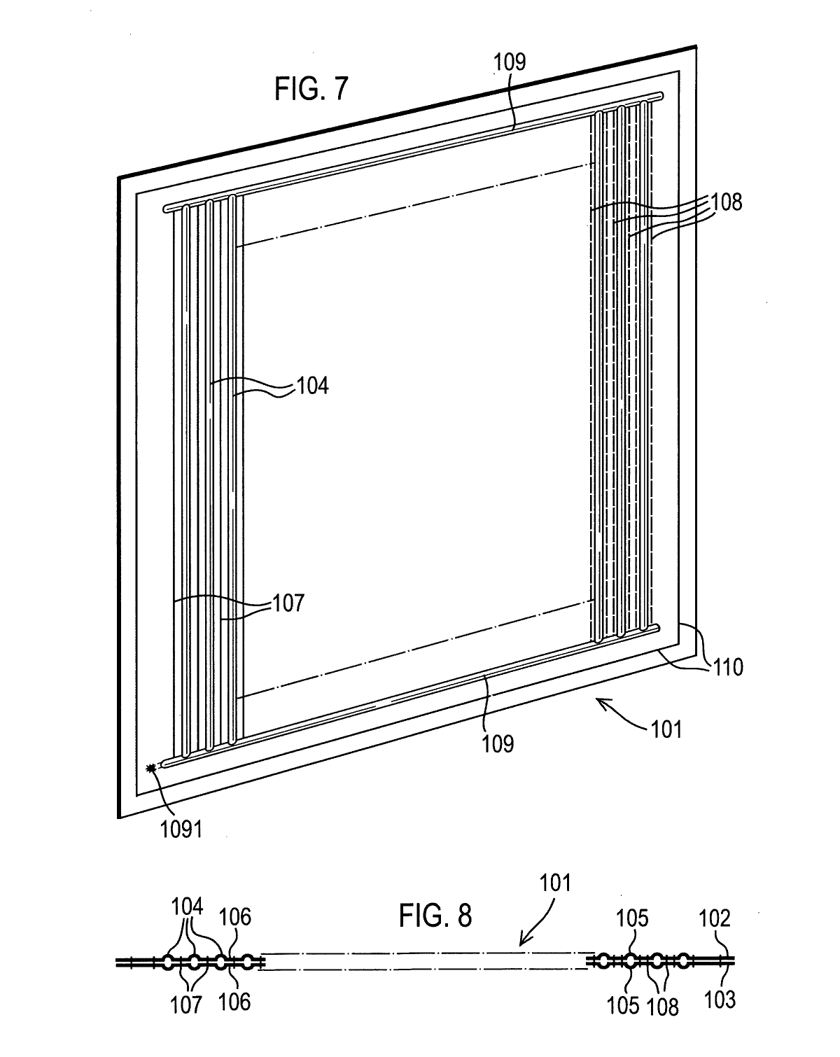

FIG. 7 is a perspective view of the welded product of FIG. 1 after hydroforming into a solar, heat pipe product;

FIG. 8 is a cross-sectional plan view of the heat pipe product of FIG. 7;

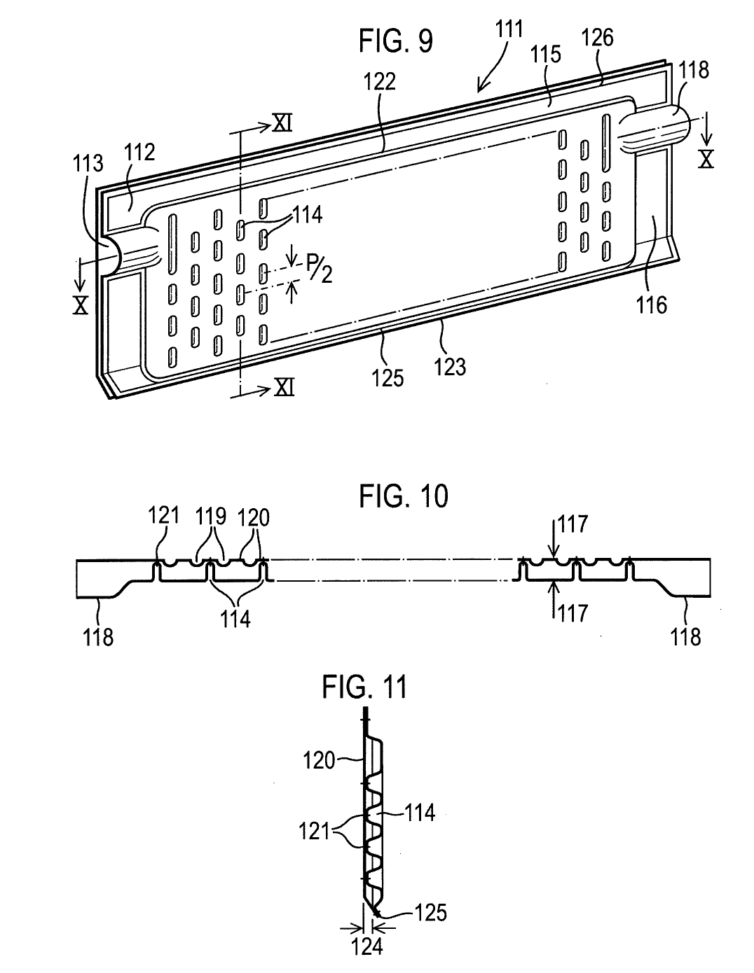

FIG. 9 is a perspective view of a heat exchanger product for the heat pipe product of FIG. 7;

FIG. 10 is a cross-sectional plan view of the heat exchanger product, taken on the line IX-Iv in FIG. 9;

FIG. 11 is a cross-sectional end view of the heat exchanger product, taken on the line X-X in FIG. 9;

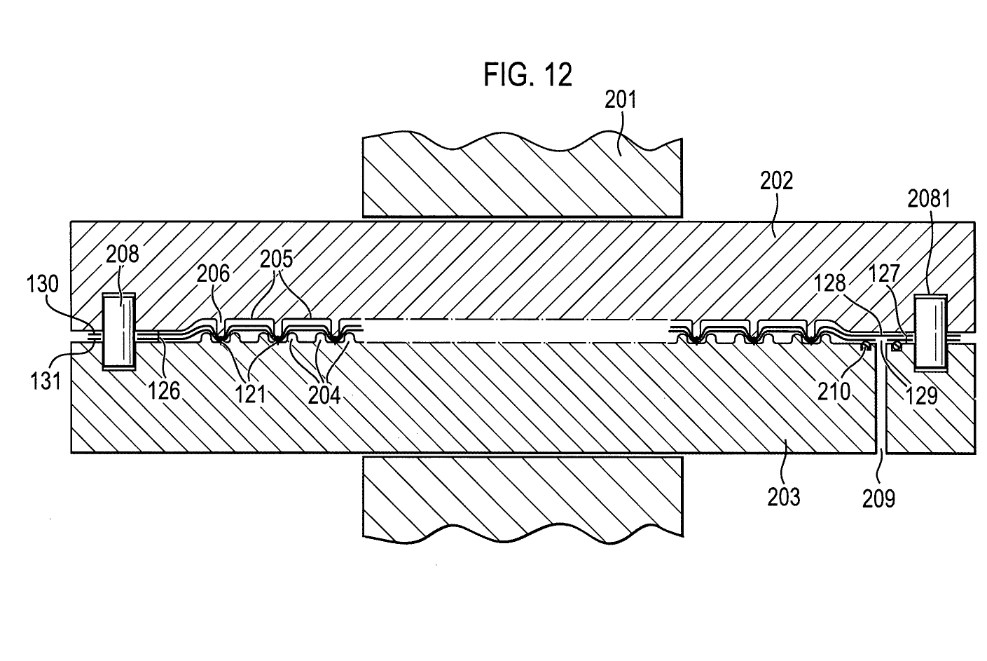

FIG. 12 is a diagrammatic cross-sectional side view of a hydro-forming press for forming the heat exchanger product;

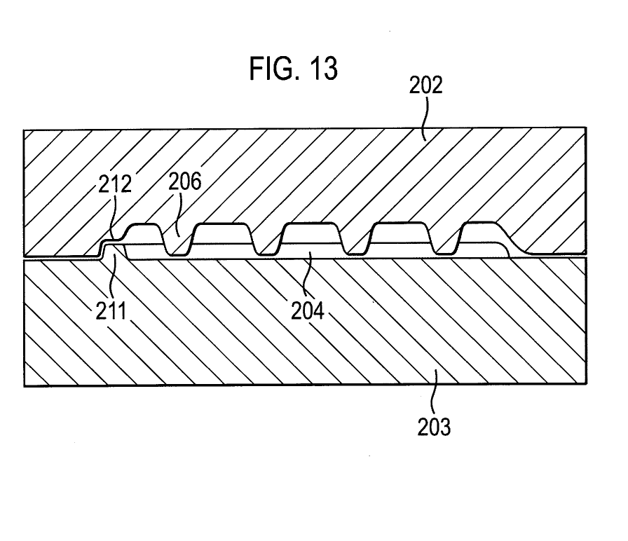

FIG. 13 is a view similar to FIG. 12 of the press tool, taken at right angles to the view of FIG. 12, without the heat exchanger sheets in the tool;

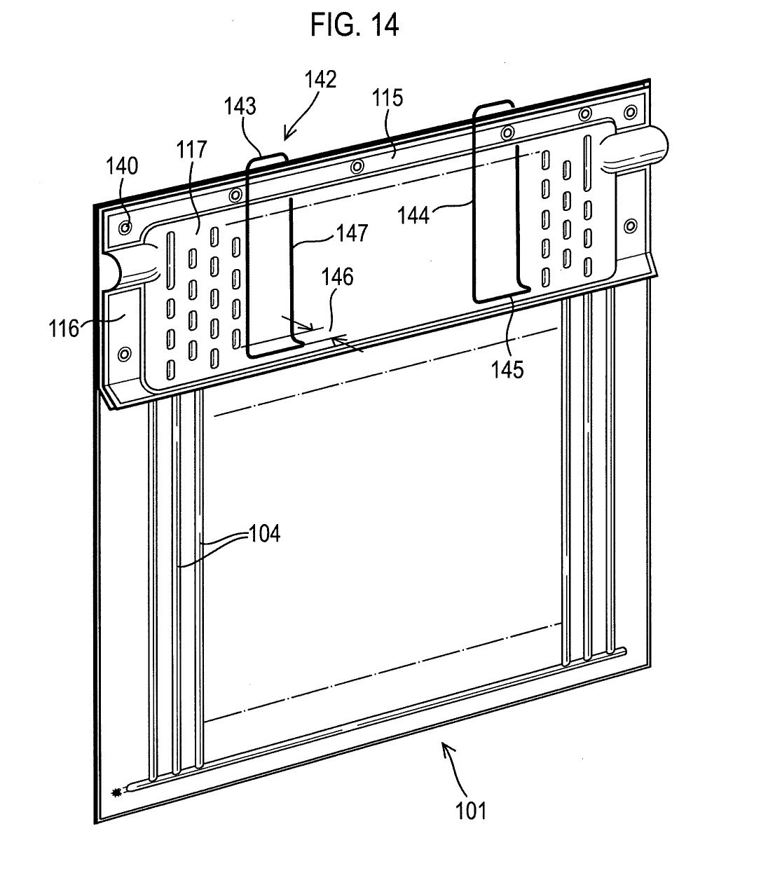

FIG. 14 is a view similar to FIG. 6 of the heat pipe product having the heat exchanger product fitted to the top margin of the heat pipe product, the combination comprising a solar collector;

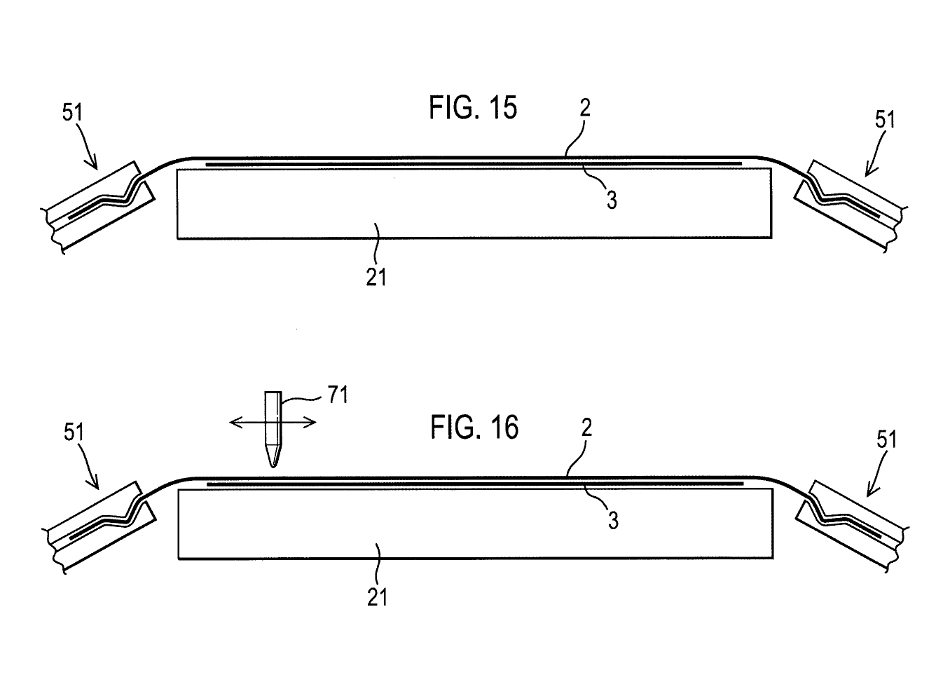

FIG. 15 is a diagrammatic view of a two sheet heat pipe panel set up for welding;

FIG. 16 is a diagrammatic view of the panel of FIG. 15 being welded;

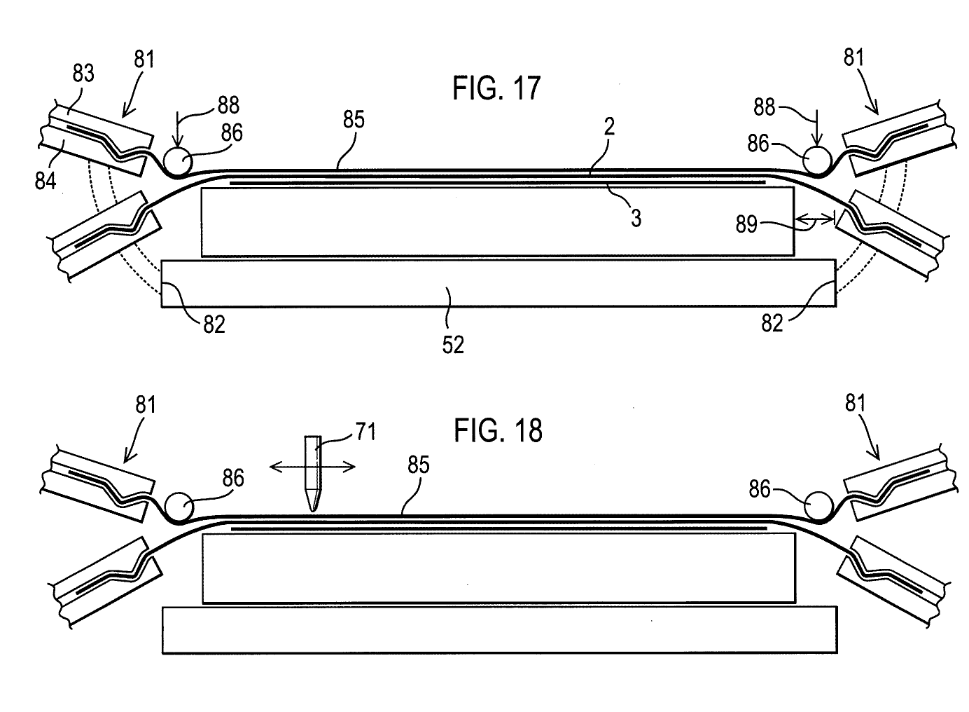

FIG. 17 is a similar view of a heat exchanger band positioned for welding to the panel;

FIG. 18 is another similar view showing the band being welded on;

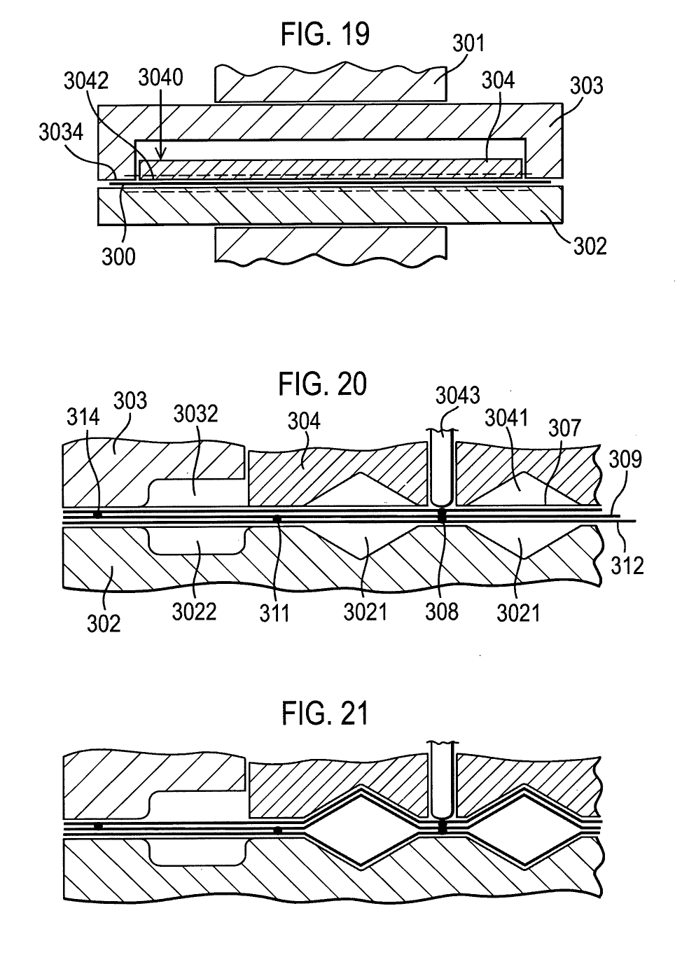

FIG. 19 is a cross-section side view of a hydroforming tool for a heat pipe panel with integrally welded heat exchanger;

FIG. 20 is a scrap view similar to FIG. 19 of side edge details of the tool and the welded product prior to hydroforming inflation;

FIG. 21 is the same view as FIG. 20 showing the heat pipes after initial inflation;

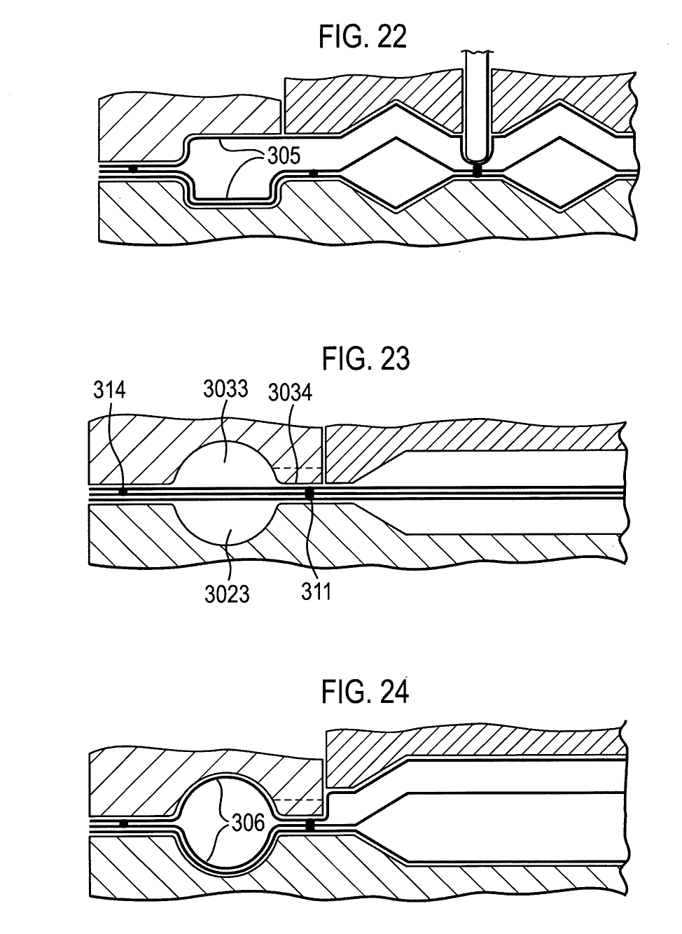

FIG. 22 is the same view again showing the heat exchanger after inflation;

FIG. 23 is similar view in an orthogonal plane showing top edge details of the tool and the welded product prior to hydroforming inflation;

FIG. 24 is the same view again after hydroforming inflation; and

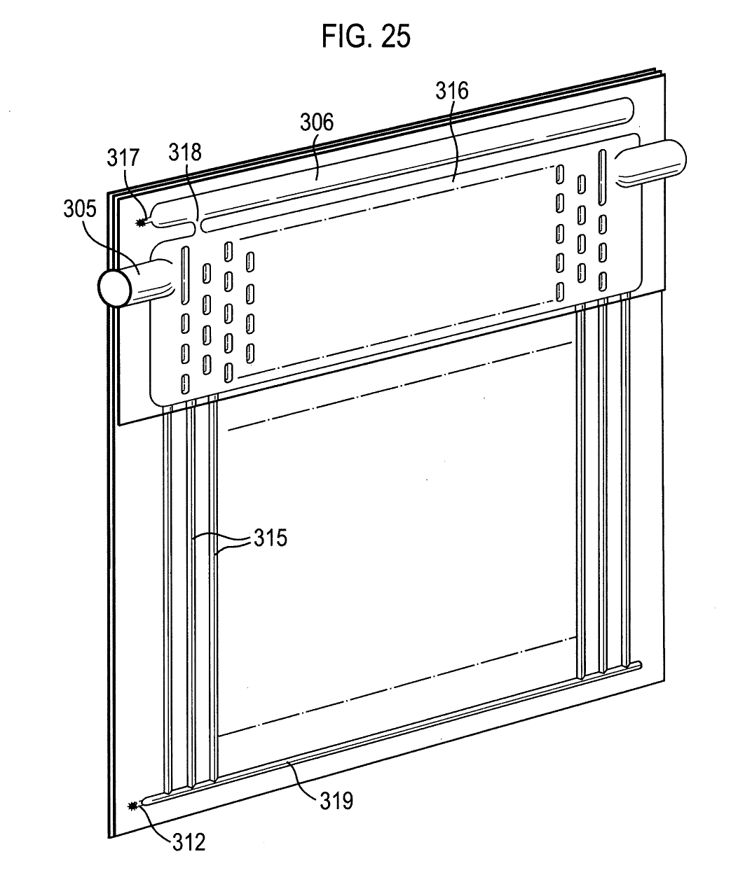

FIG. 25 is a perspective view of the finished heat pipe panel and integral heat exchanger.

Referring to FIG. 1, a welded product of the invention comprises a pair of flat, metal sheets 2,3, typically of steel and typically 0.25 mm thick and a metre square. The top sheet 2 is more extensive than the bottom sheet 3. The sheets are welded together at an array in both X & Y directions of welds 7, the welds being intermittent lines parallel with the X direction and spaced in the Y direction. A peripheral weld 10 surrounds the array of welds 7.

Turning to FIGS. 2 & 3, for making the product, a flat welding support or bed 21 is provided in its face with a series of channels 22 in register with the positions of the welds 7, 10 to be formed. The channels are pneumatically connected together to a vacuum duct 23 having a cock 24 and thence to a source of vacuum 25. The bed has a series of spring loaded pegs 26 extending up from its surface for initial location of the sheet 3. Within these is a channel 27 having a seal 28 for sealing the sheet 3 to the welding bed, whereby application of vacuum pulls the sheet against the bed.

Outside the extent of the sheet 3, an outer vacuum channel 31 is provided. It is connected to the vacuum source via its duct 32 and its cock 33. Around this, an outer seal channel 34 and seal 35 is arranged. Thus the sheet 2 when laid over the sheet 3 can be pulled down by vacuum onto it and the bed around the sheet 3.

Simple clamps 41 are arranged along one pair of edges 42 of the bed 21 for the corresponding edges 43 of the sheet 2. The clamps have outer edge ribs 44 engaging in recesses 45 in the bed. Actuators 46 beneath the welding bed have rods 47 arranged along the middle of the clamps for pulling them down. Their inner edges 48 are formed to grip the sheet 2 and hold it against the bed.

With reference to FIG. 4, at the other edges 50 of the bed, more substantial clamps 51 are provided. The welding bed is mounted on a machine structure 52. The clamps 51 are mounted on the structure 52 to be movable away from the welding bed and clamped to the machine structure by actuators 53. Between the clamps and the bed, eccentric driven clamp movers 54 are provided. They have shafts 55 journalled in bearings 56 abuttingly secured to the edges of the bed and eccentrics 57. The clamps have nibs 58 extending towards the eccentrics. A rotary actuator 59 turns the shafts to move the clamps away from the welding bed, by action of the eccentrics on the nibs. The clamps themselves are similar to the edge clamps, although more substantial, having V form jaws 60,61 for tightly gripping the sheet 2 and jaw closure actuators 62.

As shown in FIG. 5, over the welding bed is mounted a welding head having YAG laser 71 via an X/Y robotic device 72, which is of conventional design. It is arranged such that as the laser is traversed in its use position, advanced close to the welding bed, the laser head remains at a constant distance D from the welding bed.

For production of the product, a lower sheet 3 is laid on the welding bed, located by the pegs 26. Vacuum is applied to the channels 22 by opening the cock 24, pulling the sheet 3 down against the welding bed. An upper sheet 2 is then laid over the lower sheet, with the side and end clamps open. The cock 33 is opened and the top sheet is pulled down onto the lower sheet.

With the eccentrics turned to allow the end clamps to approach the welding bed, the clamps are all closed. The eccentrics are turned and the top sheet is tensioned. The jaws 60, 61 are set slightly below the surface of the welding table, whereby top sheet is pulled downwards at the edges 50 of the web and the sheets are held firmly against the welding bed, by the combination of the vacuum and the tension.

The result is that with the sheets so firmly held in position and contacting each other across the fully extent of the smaller sheet 3, the free face of the sheet 2 is parallel the face of the welding bed on which the sheet 3 is supported. In other words the face of the sheet 2 is planar.

The X/Y robot and the YAG laser are now controlled to make the welds. Once the laser is advanced to its use spacing from the sheet 2 in one position, this spacing will be maintained wherever the robot traverses the laser to. Thus, the welds can be made wherever desired for their array.

The invention is not intended to be restricted to the details of the above described embodiment. For instance, linear hydraulic actuators can be used in place of the eccentric driven clamp movers 54. Further indeed, by arranging for the sheet to be gripped at its edges, prior to full closure of the jaws, the sheet can be tensioned by action of the jaws themselves. Again, the top sheet can be stretched taut by fixing the clamps 51 to the machine structure 52 and raising the welding bed to a datum level whilst the sheet is held in the clamps 51.

Further, the invention is applicable for instance to welding a sheet to a thicker substrate. In this case, the substrate is supported on the welding bed with its surface to receive the sheet flush with the surface of the welding bed. The substrate is sealed to the welding bed and the vacuum for pulling the sheet against the substrate is pulled via the welding bed. Alternatively, where the sheet and the substrate can be sealed to each other peripherally, the vacuum can be pulled via one or more ports or ducts in the substrate and opening at the surface of the substrate which is to receive the sheet. In either case, the sheet can then be tensioned in the manner of the above described embodiment.

Referring to FIG. 6, the substrate, in this case half a turbine casing 73, is supported on a bed fixture 211 in a conventional manner, as by resting on it with location dowels 212 engaging in sockets 731 in the casing. Sheet edge clamps 511 are arranged to close in the direction of arrows A and to draw the sheet 74, in the direction of arrows B, tight onto the substrate without recourse to vacuum. The laser 711 is supported on a six axis robot 721, of which part only is shown, which enables welds to be made circumferentially and axially of the casing.

Again it can be envisaged that a part-circularly cylindrically curved welded product for instance can be made by pulling the outer of two steel sheets against a curved welding bed. For this, the robot will be adapted to follow the two dimensions of the sheet in three orthogonal dimensions.

Referring now to FIGS. 7 & 8 of the drawings, a welded (as described above) and hydroformed (in a manner similar to that described below for the heat exchanger 111) heat pipe product or solar collector panel 101 is shown, which is one metre square and has two 0.25 mm skins of stainless steel 102,103, with an array of tubes 104 formed in them; that is to say that each tube is comprised of an elongate D-section formation 105 in one skin, aligned with a similar formation in the other skin, the two D-formations providing the tube. At the sides of each tube, the skins radiate from its transverse diameter towards adjacent tubes at lands 106, which abut and are welded together by welds 107, laser formed in the manner described above. The welds unite the skins and enable them to resist the considerable internal pressure generated in the panel during use as a heat pipe. Simple line welds 107 centrally of the lands are shown in the left hand sides of FIGS. 7 and 8; whilst alternative pairs of parallel, intermittent line welds 108 are shown at the right hand side of these Figures. The welds 108 are close to the D formations in the individual skins and improve stability of the panel at the expense of substantially twice the length of weld.

The tubes are united top and bottom by transverse tubes 109, which act to equalise pressure in the tubes of the array. Hydroforming was performed in a two part tool, having the shape of the D formations cut in their opposed surfaces and an outlet for hydroforming liquid, injected into the panel via a point 1091. This was welded closed after the hydroforming liquid was withdrawn a replaced by a predetermined quantity of heat pipe liquid. A peripheral weld 110 seals the entire panel close to its edges, which are cropped.

Referring to FIGS. 9, 10 & 11, a heat exchanger product 111 for the heat pipe panel is of more complex form and is long and narrow compared with the square outline of the solar collector, the heat exchanger being designed to co-operate with the top 15% approximately of the collector. It also is of two skins 112,113. They are intermittently welded together at recesses 114 in the outer skin 112, that is where the skin not in contact with the solar panel in use. Apart from the recesses 114 and top and end margins 115,116, the entire outer skin is lifted away 117 from the inner skin, including at D section connection formations 118 in the end margins and between the recesses 114. The inner skin has pressed indentations 119 which are complementary to the tubes 104,109 of the collector. The welded recesses are at the same pitch as the lands 106.

The recesses 114 are opposite webs 120 in the inner skin, which extend between the indentations 119. Further, the recesses and the welds 121 at the bottom of the recesses are arrayed in two dimensions, the first along the webs and the second transverse to the first in the direction of the length of the heat exchanger, that is across the length of the heat pipe tubes 104. Whilst the welds in adjacent webs could be aligned with the second direction, in the preferred embodiment, it is those in alternate webs that are so aligned, with the welds in the adjacent webs being offset at half their pitch P/2 along the webs, whereby heat transfer fluid passing between each pair of welds is displaced up or down to mix thoroughly for enhanced heat pick up. In other words, the recesses 114 and their welds 121 act as flow distributors. Immediately inside the connection formations 118, longer distributors 1141 are provided to act as deflectors, deflecting flow from remaining in the top portion of the heat exchanger only and deflecting at least part of it downwards towards the bottom portion.

Except at the connection formations 118, a peripheral weld 122 is provided around the lifted away portion 117. All the welds 121 and the peripheral weld 122 are in the same plane, namely at the inside face of the inner sheet. For sealing of the heat exchanger at its edge bottom edge 123, which passes across the tubes 104, the webs 120 are bent up to the level of the furthest extent 124 of the indentations 119. The outer skin meets the inner skin at this level with a bottom extent 125 of the peripheral weld. Thus this weld is out of the plane of the other welds.

The heat pipe 1 and the heat exchanger 111 are formed essentially similarly and the formation of the heat exchanger 111 only will now be described.

For forming the heat exchanger product—referring FIGS. 12 and 13—a hydroforming press 201 is equipped with upper and dies 202,203. The lower die has upstands 204 corresponding to the indentations 119 and the upper die has generally recessed area 205 corresponding to the inflated portion 117 of the outer skin 112. Arrayed within the area 205 are non recessed pieces 206, which appear as protrusions but in fact extend only as far as the level of a peripheral region 207 of the die. The lower die has location dowels 208 and a hydroforming fluid duct 209, with a surrounding seal 210. The upper die has apertures 2081 for receiving the dowels on closure of the tool. The lower die has an upstand 211 corresponding to the height of the bottom edge of the heat exchanger, with the upper die having a complementary rebate 212.

In the manner described with reference to FIGS. 1 to 6 above, two flat sheets 112,113 of stainless steel are welded together with the array of welds 121 and the peripheral weld 122 to form a “welded product”. At this stage, the sheets are still over-size with respect to their finished size. Two extra welds 126,127 are provided. The inner 126 of these extra welds extends around the top (in use) and sides of the heat exchanger and defines the outer limit of the heater exchanger when cropped to size, around the top and end margins 115,116. The outer weld 127 is limited to defining small regions 128 outwards of the connections formations 118, which are inflated to allow full inflation of these formations to the edge of the heat exchanger, and at one side an additional area that is not inflated, but includes an aperture 129 in the inner sheet, through which hydroforming inflation fluid can be introduced into the product. This aperture is in register with the hydroforming duct 209. It should be noted at this point that the D inflations for connection are more substantial in the extent of the inflation of the outer skin than the main inflation 117. The regions 128 extend in strips of sheet material 130 to be cropped off. These strips include apertures 131 via which the sheets are located on the dowels 208.

The “welded product” is placed on the lower die, located by the dowels 208. The duct 209 is in registered with the aperture 129. The press is closed with the skins being gripped at the welds 121 by the upstands 204 and the non-recessed pieces 206. It is also gripped by faces of the dies at the margins 115,116 and at the bottom edge upstand 211 and rebate 212. During the die closing process, the lower sheet rests on the upstands 204 initially and both sheets are formed to an initial extent during complete closure. The edge margins are held in their intended position by the dowels.

Once the die is closed and clamped, hydroforming fluid is applied under pressure to the aperture 129. This inflates the outer skin to its level 117 and to create the connection formations 118. Further, between the upstands 204, the inner skin is pressed back down to the level of the margins causing it to have the indentations. These deformations occur with plastic deformation and are permanent. So far as the inner skin is concerned, the result is formation of the indentations from the original flat form of the sheet.

The heat exchanger product is finished by peripheral trimming to size.

The heat pipe is formed in like manner in a similar die. A measured quantity of water is introduced into the tubes and a vacuum is drawn in them. Its hydroforming aperture is welded closed by conventional means. The heat pipe panel thus becomes an array of heat pipe tubes.

As shown in FIG. 14, the heat exchanger is secured to heat pipe product by clinches 140 formed in the margins of the two products. Additionally to further ensure that the two products are kept in close contact remote from the clinches, double U clips 142 are provided. These are in the general configuration of paper clips. They have a short bridging limb 143 with a long gripping limb 144 extending from each end of the bridging limb to bear on opposite sides of the combined product urging the two components together. At the ends of the long limbs remote from the bridging limb, further bridging limbs 145 extend parallel to the main bridging limb. Since one of the long limbs engages the between a pair of the heat pipe tubes, the further bridging limbs are offset 146 out of the plane of the long limbs and extend across to the position of the respective other long limb. Thence further long limbs 147 extend back towards the main bridging limb. Thus the long limbs and their counterpart further long limbs grip the two components between themselves, urging the components into close contact.

Exposure to solar radiation of the combined assembly of the heat pipe product with the heat exchanger product, with the heat exchanger uppermost, causes the heat pipe to heat the heat exchanger, which heats liquid pumped through it.

Again the invention is not intended to be restricted to the details of the above described embodiment let alone its details. For instance, where the sheets have clamp formations resulting from welding of the welded product, these can be used for location in the hydroforming dies in place of the location pegs 208. Again, it is envisaged that the products could be configured as a pair of D section half cylinders for encasing a heat source requiring to be cooled, for instance a turbine. In such an application, the metal counterpart could be a thick casing to which the sheet is welded.

As an alternative to the double U clips, the pattern of the heat pipes and the heat exchanger inflations can be modified to leave a few plain, uninflated areas at which they can be clinched or indeed spot welded together remote from the margins.

It can also be envisaged the inter-sheet welds could be at the indentations in the inner sheet, although the flow rate of the heat transfer liquid is likely to decrease and/or the pressure differential for an acceptable flow is likely to increase.

Again, a simpler pattern of hydroforming similar to that of the heat pipes can be envisaged. However to provide through flow, this would need to be serpentine and is likely to require an even greater pressure differential.

Referring on to FIGS. 15 to 18 and indeed back to FIGS. 2 to 6, adaptation of the welding bed 21 to integral production of the heat exchanger with the heat pipe panel is shown. A second set 81 of the more substantial clamps 51 is arranged above the clamps 51. They are fixed to edges 82 of the machine structure 52 in a manner shown only diagrammatically. Their jaw structure 83,84 is such that they draw tight a band 85 of sheet steel inserted in them for forming the heat exchanger after the heat pipe panel has been welded. The jaws hold the band 85 above the level of the welded panel. However, rolls 86 are arranged to bear on the band close to the jaws. Non-shown actuators are provided for forcing the band in the direction 88 downwards onto the top heat panel sheet 2 at the gap 89 between the jaws 51 and the bed 21. Thus the band is brought into intimate contact with the top sheet.

The welding laser 71 can then be deployed to form the array welds necessary for the heat exchanger. In the manner that the laser was powered to give only sufficient penetration to weld the two panel sheets together, without penetration as far as the bed 21, the welding of the band, the penetration is controlled not to reach the second panel sheet 3, when welding the band to the sheet 2.

Turning on to FIGS. 19 to 25, the welded product 300 of the last two paragraphs, that is to say having one weld array between the two sheets for a heat pipe and one weld array between one of the sheets and the band for a heat exchanger is placed in a hydroforming press 301 having opposed tools 302,303. The first of these, against which a heat pipe tube abuts is unitary. The second has a movable insert 304, which abuts the heat exchanger band, with the balance of the heat pipe sheet not covered by the band abutting the tool 303. The movable insert is advanced towards the opposite took 302 for hydroforming of the heat pipes, by inflation of the heat pipe sheets and is withdrawable for inflation of the heat exchangeable band. Withdrawal allows space for such inflation. The inflation liquid is retained in the heat pipes during inflation of the heat exchanger, in order to avoid deflation of the heat pipes.

In more detail, the first tool 302 has the following recesses in it (in addition to sealing grooves etc. for inflation pressure introduction):
heat pipe grooves 3021;
connection formations 3022 (see FIG. 20), for forming heat exchange connection points 305 or at least part thereof as described below;
a stiffening rib groove 3023 (see FIG. 23), for forming a stiffening rib 306 at the top of the collector.

The fixed part of the second tool 303 has the following recesses again ignoring sealing grooves:
heat pipe grooves (not separately visible in FIG. 20);
connection formations 3032, for forming heat exchange connection points 305;
a stiffening rib groove 3033, for forming the stiffening rib 306 at the top of the collector.

The movable insert 304 has:
heat pipe grooves 3041, which are continuations of the heat pipe grooves in second tool 303, at least when the insert is advanced.

Non-shown means is provided for advancing the insert in the direction of arrow 3040 so that its front face 3042, at least at the edges of the heat pipe formations, is flush with the front face 3034 of the fixed part and indeed for withdrawal of the insert to its heat exchanger inflation position. In addition, immovable lugs 3043 extend through the insert for abutting the heat exchanger band 307 at welds 308 interconnecting the band with the heat pipe sheet 309 that it abuts. The nose of the lug is rounded 310 to apply curvature to the band when band is inflated.

It should be noted that the connection formations and the stiffening grooves are outside in the finished product of the peripheral weld 311 between the heat pipe sheets 309, 312, and the inflation point 313 is within the peripheral weld. The result is that unwanted inflation of the connection points and the stiffening rib by the heat pipe inflation is avoided. However, the peripheral weld 314 of the band 307 and second sheet 309 is outside these formations.

Actual inflation is as follows:
1. The tool is closed on the welded sheets with the insert advanced. The heat pipes 315 are inflated;
2. The insert is withdrawn, with the inflation liquid locked in the pipes. No additional liquid is applied and it is not pressurised, but equally it cannot escape and becomes pressurised as now explained;
3. The heat exchanger is inflated via its inflation point 317. This applies pressure to the heat pipe inflation liquid via the sheet 309, acting as a diaphragm. However, since the liquid cannot escape, the sheet 309 does not deform. The act of inflation moves the heat exchanger band away from the heat pipes where the latter has been impressed in it. The exception is where the lugs 3043 and the welds 308 hold the band and the sheet together. In addition, the inflation moves the band into the connection formations 3032 and the stiffening rib groove 3033. Equally it moves the two sheets into the connection formations 3022 and the stiffening rib groove 3023. The connection points 305 interconnect with the bulk inflation of the band at the heat pipes, because the connection formations extend as far as the movable insert. The stiffening rib is connected by a single narrow passage 318 only formed by a single channel indicated at 3034 for inflation with the bulk of the inflated interior, not least to avoid the stiffening rib providing a short circuit for flow of heat exchange fluid bypassing the heat pipes in use. The general shape of the inflated heat exchanger is similar to the that shown in FIG. 3 and will not be described in more detail, save to say the stiffening rib is to avoid general deformation of the heat panel, which is stiffened by the heat pipes themselves in their direction but is otherwise able to bend transverse to their direction.

It should be noted that the heat pipe inflations 315 of this embodiment are trapezoidal. This provides improved meniscus/capillary action return downwards flow of the heat pipe fluid condensed in the heat exchanger, whilst vaporised fluid rises up the tube, transferring heat with it to the heat exchanger. The heat pipe inflations are interconnected at their bottom only by a single inflated interconnection 319.

It should be noted that whilst the heat pipe panel is suitable for use as a solar collector, it can be used to collect radiant heat in other applications and indeed to cool a convective or forced circulation fluid flow.

1.-59. (canceled)

60. A method of forming a welded metal product from a workpiece comprising a workpiece sheet and a workpiece counterpart to which the workpiece sheet is to be welded, the method consisting in the steps of:
providing:
a workpiece support having a support surface for a workpiece counterpart,
means for:
gripping opposite edges of a workpiece sheet at respective opposite edges of the workpiece support,
drawing the opposite workpiece sheet edges in a direction having a component from a workpiece counterpart on the support surface towards the support surface and
holding the opposite workpiece sheet edges in their drawn position,
a robotic device associated with the workpiece support and
a laser welding head arranged to be moved by the robotic device in at least two dimensions with respect to the workpiece support, and to maintain a welding gap from a free face of the workpiece sheet on the supported workpiece counterpart in accordance with an array welds to be formed in welding together the workpiece sheet and the workpiece counterpart;
placing a workpiece counterpart on the workpiece support;
placing a workpiece sheet on the workpiece counterpart;
gripping, drawing and holding taught the workpiece sheet by opposite edges thereof to lie against the workpiece counterpart, captivating the latter, with the free face of the workpiece sheet defining a regular surface;
setting up the combination of the workpiece support, the robotic device and the laser welding head such that the welding gap is maintained between the laser welding head and the regular surface throughout traversing of the laser welding head for forming the array of welds;
traversing the laser welding head across the workpiece sheet and making the array of laser welds, thereby welding together the workpiece sheet and the workpiece counterpart, the array being two dimensional with respect to the workpiece sheet.

61. A method according to claim 60, wherein the workpiece support and the gripping, drawing and holding means are fixed with respect to a chassis of the robotic device, the robotic device being adapted to move the welding head in at least two dimensions with respect to the chassis to execute the two dimensional array of welds between the workpiece sheet and workpiece counterpart, or the workpiece support and the gripping, drawing and holding means are mounted for movement in one dimension with respect to a chassis of the robotic device, the robotic device is adapted to move the workpiece support and the gripping, drawing and holding means in the one dimension and to move the welding head in another dimension with respect to the chassis, whereby the welding head and the workpiece sheet can execute the two dimensional array of welds between the workpiece sheet and workpiece counterpart, or the workpiece support and the gripping, drawing and holding means are mounted for movement in two dimensions with respect to a chassis of the robotic device, the robotic device is adapted to move the workpiece support and the gripping, drawing and holding means in the two dimensions and to hold the welding head in still in these dimensions with respect to the chassis, whereby the welding head and the workpiece sheet can execute the two dimensional array of welds between the workpiece sheet and workpiece counterpart.

62. A method according to claim 60, wherein the workpiece support is adapted to the hold the workpiece counterpart against it by drawing a vacuum between them and a vacuum is maintained between the support and the workpiece counterpart during the welding step, or the workpiece support is adapted to the hold the workpiece sheet against the workpiece counterpart by drawing a vacuum between them and a vacuum is maintained between the workpiece sheet and the workpiece counterpart during the welding step.

63. A method according to claim 60, wherein the workpiece sheet and the workpiece counterpart are of the same order of magnitude in thickness, and their shape in a third dimension orthogonal to the two dimensions is that of the workpiece support, or the workpiece counterpart is thicker than the workpiece sheet by an order of magnitude in thickness, whereby the workpiece counterpart is a thick part, in contrast to the thinness of the workpiece sheet and rigid in contrast to the workpiece sheet's flexibility.

64. A method according to claim 60, wherein the workpiece counterpart is held on the workpiece support by action of the gripping, drawing and holding means on the workpiece, or the workpiece counterpart is held on the workpiece support by conventional clamping means.

65. A method according to claim 60, wherein the workpiece support, the workpiece counterpart and the two dimensional array are all flat and the robotic device is an X/Y or Cartesian robot or the robotic device is a four or six axis robot.

66. A method according to claim 60, wherein the workpiece support, the workpiece counterpart and the two dimensional array are all part circularly cylindrical, the greater part of the weld length being parallel to a central longitudinal axis or being circumferential.

67. A method according to claim 60, wherein the array of welds define a plurality of heat pipes strips extending in one direction in the welded product, an interconnection strip extending in an orthogonal direction and a first inflation point, with one of the workpiece sheet and the workpiece counterpart being perforate at the first inflation point.

68. A method according to claim 67, including the additional steps of:
placing the welded metal product in a hydroforming tool and
applying pressurised liquid to the first inflation point to inflate/hydroform the heat tube strips and the interconnection strip.

69. A method according to claim 67, including the additional steps of:
gripping, drawing taught and holding an additional band of sheet metal for a heat exchanger across hot (in use) ends of the heat pipe strips and
forming a second array of welds between the workpiece sheet and the heat exchanger band in like manner to the first array of welds between the workpiece and the workpiece counterpart, the second array of welds defining a heat exchanger area, connections thereto and a second inflation point.

70. A method as claimed in claim 69, including the additional steps of:
placing the welded metal product in a hydroforming tool,
applying pressurised liquid to the first inflation point to inflate/hydroform the heat tube strips and the interconnection strip,
holding the pressure of the liquid in the inflated heat pipe tube strips,
applying pressurised liquid to the second inflation point to inflate/hydroform the heat exchanger area and the connections thereto.

71. A method according to claim 70, including the additional steps of:
forming welds, between the workpiece sheet and the workpiece counterpart and outside the peripheral weld, around the position of complementary connection formations to the heat exchanger,
on inflation of the heat exchanger area, including the connections thereto, inflating the workpiece sheet and the workpiece counterpart to form the complementary connection formations, whereby the connection and complementary inflations/formations in all three parts define a round orifice and
welding or soldering connection tubes into the connection formations.

72. A method according to claim 68, including the additional steps of:
forming a loop of weld between the workpiece sheet and the counterpart and/or between the workpiece sheet and the heat exchanger band (where provided) for a stiffening rib at a heat exchanger end of the heat pipe strips and a single connection to the heat exchange area,
inflating/hydroforming the stiffening rib with the heat exchange areas and the connections thereto and
withdrawing the hydroforming liquid.

73. A method according to claim 68, including the additional steps of:
forming a loop of weld between the workpiece sheet and the counterpart and/or between the workpiece sheet and the heat exchanger band (where provided) for a stiffening rib at a heat exchanger end of the heat pipe strips and around a third inflation point for the stiffening rib without connection to the heat exchange area and
inflating/hydroforming the stiffening rib from the third inflation point as a separation operation to inflating/hydroforming the heat exchanger area and
withdrawing the hydroforming liquid.

74. Apparatus for forming in accordance with claim 60, a welded metal product from a workpiece comprising a workpiece sheet and a workpiece counterpart to which the workpiece sheet is to be welded, the apparatus comprising:
a workpiece support having a support surface for a workpiece counterpart placed thereon,
means for:
gripping, at respective opposite edges of the workpiece support, opposite edges of a workpiece sheet placed on the workpiece counterpart,
drawing the opposite workpiece sheet edges in a direction having a component from a workpiece counterpart on the support surface towards the support surface and
holding the opposite workpiece sheet edges in their drawn position,
a robotic device associated with the workpiece support and
a laser welding head arranged to be moved by the robotic device in at least two dimensions with respect to the workpiece support, and to maintain a welding gap from a free face of the workpiece sheet on the supported workpiece counterpart in accordance with an array welds to be formed in welding together the workpiece sheet and the workpiece counterpart.

75. Apparatus according to claim 74, wherein the workpiece support has
an interconnected array of grooves complementary to the array of welds to be formed and
a vacuum connection to the array,
the arrangement enabling vacuum to draw the workpiece counterpart against the support surface for welding.

76. Apparatus according to claim 75, wherein the workpiece support has a peripheral counterpart seal around the vacuum grooves for sealing the workpiece to the workpiece support.

77. Apparatus according to claim 76, wherein the workpiece support has
a further vacuum groove and connection thereto outside the counterpart seal and a vacuum connection thereto and
a further vacuum seal around the further groove,
the arrangement enabling vacuum to draw the workpiece sheet down onto the workpiece counterpart for welding.

78. Apparatus according to claim 74, wherein the workpiece support is rectangular or at least four sided for four sided workpiece counterpart and workpiece sheets and the gripping, drawing and holding means are arranged at two opposite side, with clamping means being provided at the other two opposite sides.

79. Apparatus according to claim 74, wherein:
the workpiece support is angled away from the support surface to enable the gripping, drawing and holding means to draw the workpiece sheet in the direction of the support surface;
the gripping, drawing and holding means includes clamps set back from the support surface for drawing the workpiece sheet in the direction of the support surface or the clamps are V jaw clamps adapted to draw tight the workpiece sheet as they are tightened closed; and
the clamps are adapted to be moved away from the workpiece support for tightening the workpiece sheet.

80. Apparatus according to claim 74, including:
a second gripping, drawing and holding means for a heat exchange band arranged above and outwards of the first gripping, drawing and holding means and
rolls and actuators therefor for forcing the band downwards onto the workpiece sheet for welding thereto.

81. Apparatus according to claim 80 in combination with a hydroforming apparatus including:
a first hydroforming tool having an array of first heat pipe concavities and
a second hydroforming tool having:
a complementary array of second heat pipe concavities and
a movable insert having:
continuations of the second heat pipe concavities and
means for its withdrawal from an advanced position in which the second heat pipe concavities and the continuations are substantially aligned to a withdrawn position hydroforming of the heat exchange band.

82. An apparatus combination according to claim 81, wherein the first hydroforming tool and/or the second hydroforming tool and/or the movable insert has further connection and/or stiffening concavities discrete from the heat pipe concavities.

83. A heat collection device comprising components formed in accordance with claim 69, the device having:
a laser welded and hydroformed heat pipe panel, comprised of a metal workpiece sheet and a metal workpiece counterpart, the workpiece sheet being welded to the workpiece counterpart with an array of welds and inflated away from the counter part to form a series of heat pipes filled with heat pipe liquid, and
a laser welded and complementarily hydroformed heat exchanger, comprised of a metal workpiece sheet and a metal workpiece counterpart, the workpiece sheet being welded to the workpiece counterpart with another array of welds and inflated away from the workpiece counterpart to form inflations complementary to end portions of the series of heat pipes, the panel and the heat exchanger being in intimate thermal contact for condensing liquid in the heat pipe panel at one end of the series of heat pipes and transferring heat therefrom.
